(19) United States
(12) Patent Application Publication
(10) Pub. No.: US 2013/0291675 A1
(43) Pub. Date: Nov. 7, 2013

(54) SHIFT LEVER FOR A TRANSMISSION OF A MOTOR VEHICLE, THE SHIFT LEVER HAVINGA BLOCKING CONNECTION

(71) Applicant: GM GLOBAL TECHNOLOGY OPERATIONS LLC, Detroit, MI (US)

(72) Inventors: Hans-Juergen BURGER, Nauheim (DE); Sven FLORENZ, Einbeck (DE)

(21) Appl. No.: 13/867,791

(22) Filed: Apr. 22, 2013

(30) Foreign Application Priority Data
Apr. 21, 2012 (DE) 102012008027.1

(51) Int. Cl. F16H 59/02

(52) U.S. Cl. CPC F16H 59/0278
USPC 74/473.24

(57) ABSTRACT

Disclosed is a shift lever for a transmission of a motor vehicle, wherein the shift lever comprises a blocking device, which can be brought from a blocking position into a release position via an active element arranged on an actuating device, wherein the active element comprises an engagement lug, which can be engaged in a latching hook arranged on the blocking device, wherein the active element is supported at the back on a rear wall located opposite the latching hook.

### CROSS-REFERENCE TO RELATED APPLICATION

This application claims priority to German Patent Application No. 10 2012 008 027.1, filed Apr. 21, 2012, which is incorporated herein by reference in its entirety.

### TECHNICAL FIELD

The technical field relates to a shift lever for a transmission of a motor vehicle, wherein the shift lever comprises a blocking device, which can be brought from a blocking position into a release position via an actuating device.

### BACKGROUND

Shift levers with blocking devices are known per se. The blocking device can be actuated via an active element, which is connected to the blocking device via a tensile strap end that can be manually clipped in. This form of connection can result in rattling noises. The clipping in of the tensile strap end requires an additional manual step during the assembly of the transmission.

At least one object herein is to provide a shift lever with a connection between the active element and the blocking device that is easy to assemble. In addition, other objects, desirable features and characteristics will become apparent from the subsequent summary and detailed description, and the appended claims, taken in conjunction with the accompanying drawings and this background.

### SUMMARY

In accordance with an exemplary embodiment, a shift lever for a transmission of a motor vehicle is provided. The shift lever includes a blocking device, which can be brought from a blocking position into a release position via an active element arranged on an actuating device. The active element comprises an engagement lug, which can be engaged in a latching hook arranged on the blocking device. The active element in the region of the engagement lug is supported at the back on a rear wall.

In an embodiment, the blocking device is a reverse gear inhibitor of a manually shiftable transmission. It serves to prevent an intentional engaging of a reverse gear while driving. The blocking device can in principle also be a gear selection inhibitor of an automatic transmission, in which individual driving stages can only be engaged when the blocking device is in the released position.

Through the rear wall, the active element is supported located opposite the engagement lug. The active connection is supported on the rear wall. During the assembly, the rear wall guides the active element until it audibly engages in the latching hook. One movement of the active element in the direction of the blocking device is required for this and no additional operation. Because of this, a stable connection can be provided between the active element and the blocking device which can be easily assembled.

In a configuration, the rear wall is embodied flat.

Through the flat configuration of the rear wall, the active element can be easily pushed into its position. Furthermore, the rear wall supports the active element located opposite the engagement lug in a flat manner and facilitates inserting and engaging of the active element on the latching hook.

According to a further configuration, the active element comprises a spring element, which presses the engagement lug of the active element in the engaged state in the blocking direction against a top side of the latching hook.

Because of this, the active element in the engaged state is also connected to the blocking element in an active direction of the active element without play.

According to another embodiment, the spring element is formed through a ring portion arranged at the end side on the active element.

Through this configuration, an active element can be provided, which on the end side is flexible so that it can be reversibly pressed in. Here, the material characteristics of the active element are utilized for providing the spring element and the spring element is unitarily joined to the active element. Furthermore, elements standing away from the active element, could get hooked up on the blocking device or on other components during the assembly are avoided. Thus, the spring element facilitates the assembly of the active element on the blocking device.

According to a further embodiment, the blocking device comprises a guide portion, which is arranged above the latching hook and is configured in order to engage about the active element.

According to another embodiment, the guide portion comprises rounded-off portions.

The rounded-off portions center the active element during the inserting into the guide portion, so that the active element in this case assumes the correct position with respect to the blocking device, as a result of which the assembly is facilitated.

According to a further embodiment, the latching hook in a state not engaged in the active element is inclined towards the flat rear wall.

Because of this, the latching hook presses the active element against the rear wall, so that a play-free connection can be provided, which is rattle-free and stable.

### BRIEF DESCRIPTION OF THE DRAWINGS

The various embodiments will hereinafter be described in conjunction with the following drawing figures, wherein like numerals denote like elements, and wherein:

FIG. 1 is schematically a top view of a motor vehicle having an engine and a transmission;

FIG. 2 is schematically a shift lever for the motor vehicle, which is pivotably arranged on the motor vehicle and comprises a blocking device in accordance with an exemplary embodiment;

FIG. 3 is a perspective representation of a blocking device with an active element that can be engaged therein according to an exemplary embodiment;

FIG. 4 is the blocking element with an active device engaged therein according to an exemplary embodiment; and

FIG. 5 is a partially sectioned lateral representation of the blocking element with the active element engaged therein according to an exemplary embodiment.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

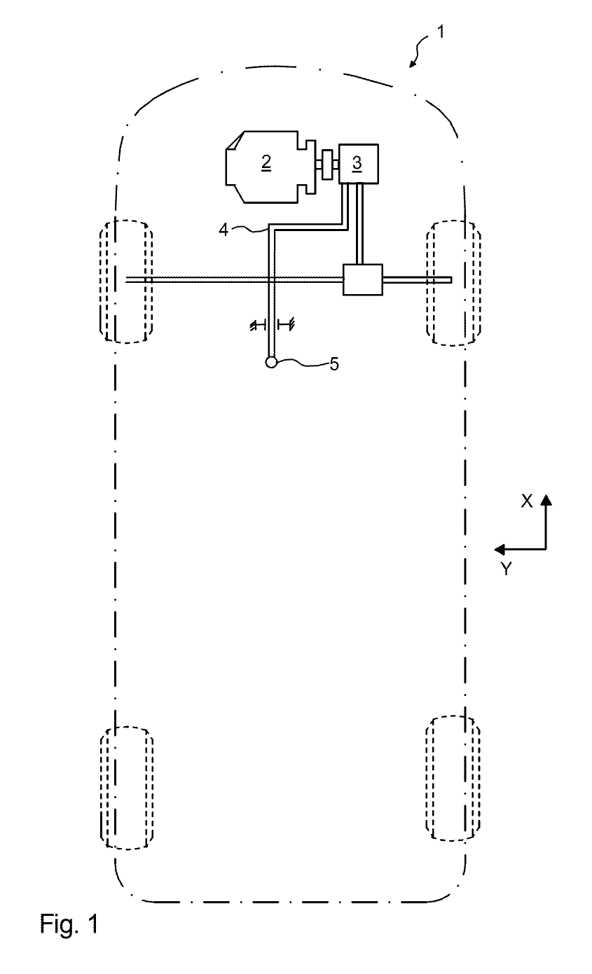

FIG. 1 schematically shows a top view of an outline of a motor vehicle 1, with an engine 2 arranged therein and a transmission 3. The transmission 3 is actively connected to a shift lever 5 via a transmission device 4. The transmission device 4 can be formed in the manner of a control cable shift, in which tensile forces from the shift lever 5 can be transmitted to the transmission 3 via control cables. By way of the shift lever 5, different driving stages can thus be engaged in the transmission 3.

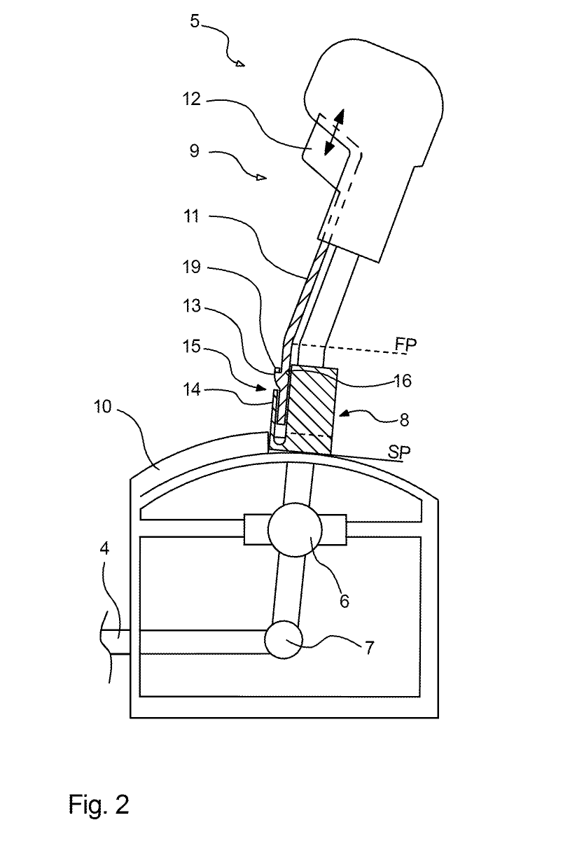

FIG. 2 shows a lateral representation of the shift lever 5. The shift lever 5 is pivotably mounted on the motor vehicle via a first bearing 6. By way of a second bearing 7, the shift lever 5 is connected to the transmission device 4. In order to prevent unintentional engaging of the reverse gear while driving forward, the shift lever 5 comprises a blocking device 8, which can be brought from a blocking position SP into a release position FP via an actuating device 9. The blocking position SP is represented with continuous lines and the releases position FP is represented with interrupted lines. In the release position FP, the blocking device 8 can overcome a blocking wall 10 and be moved further towards the left.

The blocking device 8 can be moved from the blocking position SP into the release position FP via an active element 11. The active element 11 is connected to a button 12, which can be pulled upwards corresponding to the arrow directions and automatically moves downwards again when it is released. On the active element 11, an engagement lug 13 is arranged, which can be engaged into a latching hook 14 arranged on the blocking device 8. To receive the engagement lug 13, the latching hook 14 comprises a recess 15.

On a side facing the latching hook 14, the blocking device 8 comprises a rear wall 16, which supports the active element 11 so that the latching hook 14 can establish a force on the active element 11 in the direction of the rear wall 16.

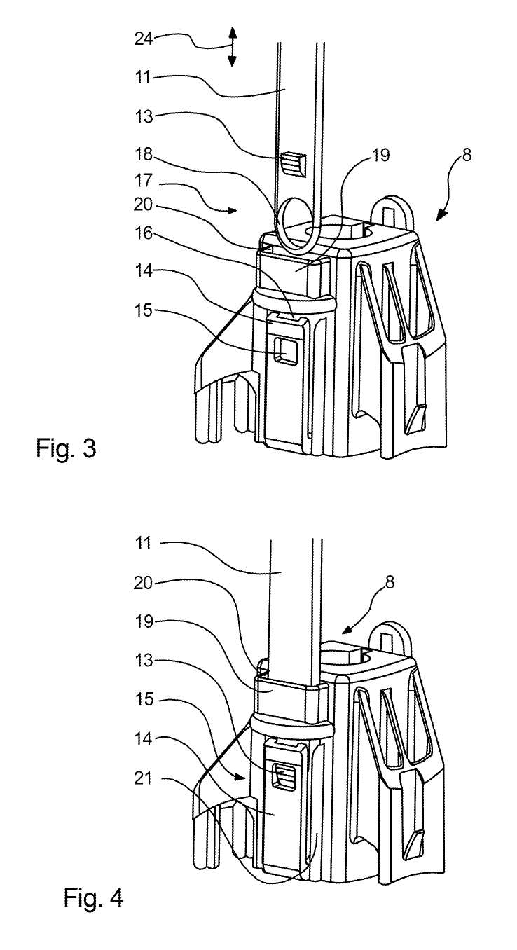

FIG. 3 shows from a perspective representation a blocking device 8 with an active element 11 that can be engaged therein. On the end side, the active element 11 comprises a spring element 17 which is formed from a ring portion 18. To this end, the spring element 17 is configured in order to hold the active element 11 free of play in an active direction 24 in the state engaged in the blocking device 8. To this end, the spring element 17 presses the engagement lug 13 against the recess 15 in the latching hook 14. The blocking element 8 and the active element 11 can be parts produced in an injection molding process. Here, the injection molding process can be configured so that the material shrinkage during the cooling-down phase or polymerization which normally has to be taken into account during the design is not taken into account with the latching hook 14. This means that a mold provided for the injection molding process in the region of the latching hook 14 only has the dimensions which would be ideally (without material shrinkage) required for receiving the active device 11. During the cooling-down phase and the polymerization, the latching hook 14 is bent in the direction of the flat rear wall 16, so that it is preloaded in the direction of the active element 11. Because of this, the latching hook 14 always presses the active element 11 in the assembled state against the flat rear wall 16. Because of this, a play-free connection between the latching hook 14 and the active element 11 in the direction that is orthogonal to the active direction 24 is achieved.

Owing to the fact that the spring element 17 is formed from a ring portion 18, the active element 11 is weakened on the end side. Because of this, an easier deformability and thus the resilient characteristic of the active element 11 that is desired in active direction 24 is achieved. Here, the spring element 17 in this configuration does not have any anti-levered or projecting elements, so that it can be easily introduced into a guide portion 19 arranged on the blocking element 8. To further facilitate the inserting, the guide portion 19 has rounded-off portions 20 on its side facing away from the flexible latching hook 14.

In a perspective representation, FIG. 4 shows an active element 11 engaged in a blocking device 8. It is evident that the engagement lug 13 is engaged in the recess 15 on the latching hook 14. The blocking device 8 comprises lateral guide portions 21, which center the active element 11 and align the engagement lug 13 in this way with respect to the recess 15 in the latching hook 14.

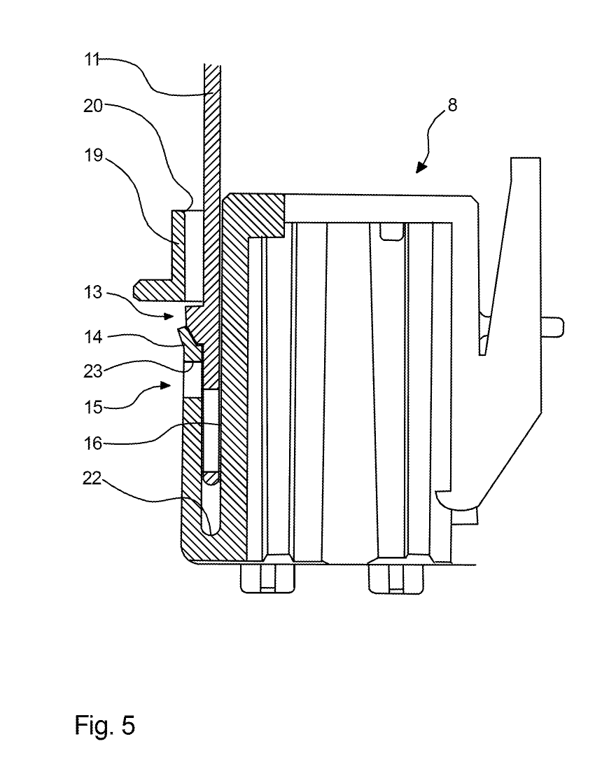

FIG. 5 shows a blocking device 8 with an active element 11, whose engagement lug 13 has just come into engagement with the recess 15 of the latching hook 14. For engaging, the active element 11 is pushed further down wherein the flexible latching hook 14 is bent to the left in FIG. 5, until the engagement lug has advanced as far as to the recess 15 in which it engages. In the engaged state, the spring element 17 presses against a bottom 22 on the blocking device 8 and thus presses the engagement lug 13 against a top side 23 of the opening 15. Because of this, the freedom of play in active direction 24 is achieved in the manner described above.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. A shift lever for a transmission of a motor vehicle, wherein the shift lever comprises:
an actuating device;
an active element arranged on the actuating device and comprising an engagement lug;
a blocking device capable of moving from a blocking position into a release position, via the active element, wherein the engagement lug is engagable in a latching hook arranged on the blocking device, and wherein the active element is supported at a back on a rear wall located opposite the latching hook.

2. The shift lever according to claim 1, wherein the rear wall is flat.

3. The shift lever according to claim 1, wherein the active element comprises a spring element, which in the engaged state presses the engagement lug of the active element into a recess arranged on the latching hook in which the engagement lug engages.

4. The shift lever according to claim 3, wherein the spring element is formed through a ring portion arranged on an end side on the active element.

5. The shift lever according to claim 1, wherein the latching hook is flexible, and wherein the blocking device comprises a guide portion that is arranged above the latching hook and is configured to engage about the active element.

6. The shift lever according to claim 5, wherein the guide portion on a side facing away from the latching hook comprises rounded-off portions.

7. The shift lever according to claim 1, wherein the rear wall is flat and the latching hook is inclined towards the rear wall in a state in which it is not engaged in the active element.
